(19) United States
(12) Patent Application Publication
(10) Pub. No.: US 2007/0276772 A1
(43) Pub. Date: Nov. 29, 2007

(54) RealTimeResume.com. RealTimeResume.org., RealTimeResume.net

(76) Inventor: Carla Maria Dunn, Attleboro, MA (US)

Correspondence Address: JOHN J. BROOKS, III, 20 WYSTERIA WAY, WRENTHAM, MA, 02093, US

(21) Appl. No.: 11/704,502

(22) Filed: Feb. 12, 2007

Related U.S. Application Data
(60) Provisional application No. 60/783,252, filed on Mar. 17, 2006.

(51) Int. Cl. G06F 17/00

(52) U.S. Cl. 705/500

(57) ABSTRACT

RealTimeResume.com is a new and innovative web invention that has the potential to profoundly impact the global employment industry in a positive and unique way. RealTimeResume.com will have a positive and profound impact on the way the employment & business industry engages in daily interviews. The ability to engage in a RealTimeResume.com video conference from anywhere in the world, will minimize interview time and eliminate initial interview travel. RealTimeResume.com's ultimate goal: encouraging and promoting economic global conservation while fostering employment and business opportunities to millions of people daily throughout the United States and abroad!

### CROSS-REFERENCE TO RELATED APPLICATIONS

This application claims the benefits of and priority to U.S. Provisional Patent Application Ser. No. 60/783,252 filed on Mar. 17, 2006 the disclosure of which is hereby incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

RealTimeResume.com will have a positive and profound impact on the way the employment & business industry engages in daily interviews. The ability to engage in a RealTimeResume.com video conference from anywhere in the world, will minimize interview time and eliminate initial interview travel. RealTimeResume.com's ultimate goal: encouraging and promoting economic global conservation while fostering employment and business opportunities to millions of people daily throughout the United States and abroad!

### BRIEF SUMMARY OF THE INVENTION

RealTimeResume.com provides a dynamic and unique personalized website that promotes and empowers each individual's specific talents relative to obtaining employment or promoting one's business. This creation allows potential employers or consumers to read about, watch and engage in real time interviews. With RealTimeResume.com, one can be empowered, be recognized and be successful.

The claim of RealTimeResume.com is to have a positive and profound impact on the way the employment & business industry engage in daily interviews. The ability to engage in a RealTimeResume.com instant message, video conference from anywhere in the world, will minimize interview time and eliminate initial interview travel. RealTimeResume.com's ultimate goal: encouraging and promoting economic global conservation while fostering employment and business opportunities to millions of people daily throughout the United States and abroad!

### BRIEF DESCRIPTION OF THE SEVERAL VEIWS OF THE DRAWING

FIG. 1. Shows a system diagram of one embodiment of the RealTimeResume.com system.

FIG. 2. Shows a diagram of one embodiment of the user interface for the RealTimeResume.com system.

FIG. 3. Shows a process flow diagram of the methods of the RealTimeResume.com system.

### DETAILED DESCRIPTION OF THE INVENTION

To promote global employment opportunities to millions of people as well as, providing a networking space for website companies to engage in real time business connections.

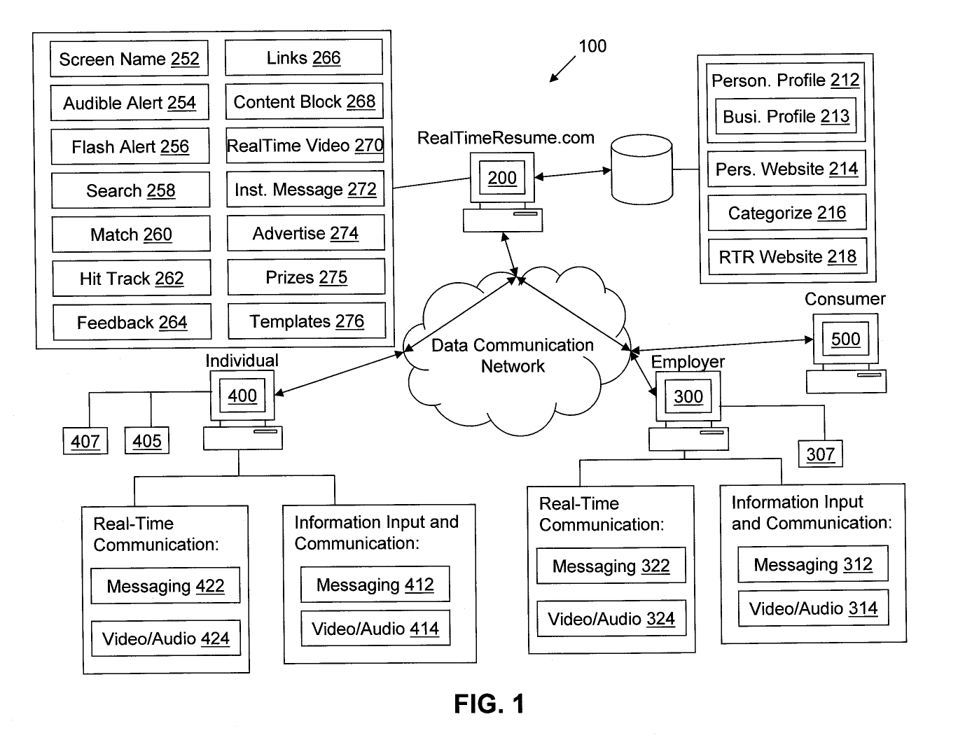

As shown in FIG. 1, RealTimeResume.com 200 provides the ability to upload a personalized resume 412 that allows the option of including a video clip 414 articulating the owner's 400 attributes 212. With RealTimeResume.com 100, live video 424 and 324 interviews 270 happen at the click of a button 407 and 307 producing—real time results.

RealTimeResume.com 200 provides a dynamic and unique personalized website 214 that promotes and empowers each individual's 400 specific talents relative to obtaining employment or promoting one's business. This creation allows potential employers 300 or consumers 500 to read 312 about, watch 314 and engage in real time interviews 270 and 272. With RealTimeResume.com, one can be empowered, be recognized and be successful.

A simple and easy website access 405 that allows uploading of a personalized resume 412 which can include the submission of a video clip 414 that articulates the owner's attributes 212. RealTimeResume.com 100 requires being assigned a secured screen name 252 that flashes when the owner 400 of the resume 412 is online at the same time their resume (212)/business profile 213 is being read. The person 300 (or 500) reading the resume 212 can send an instant message 322 and 422 requesting an opportunity to engage in an instant real time resume interview 270 and 272. Users must register acknowledgement of their age, 18 years or older before uploading on RealTimeResume.com. Only the resume owner 400 and RealTimeResume.com 200 has the ability to alter the site 214. Website 218 will be categorized 216 by resumes (212)/business profiles 213 connecting to 266: field, expertise, company, zip code, salary, benefits etcetera. When a search 258 has been matched 260, a sound alert 254 echo's simultaneously from employee 400/employer 300 computers. This instant match 260 allows the opportunity to engage in a real-time interview 270 and 272 from anywhere in the world. The owner 400 of the resume 212 can see the number of hits 262 made on their site 214 encouraging constant interaction with RealTimeResume.com 200. Once an interview has taken place on RealTimeResume.com 200, the potential employee 400 and employer 300 have the ability to provide a feedback response 264. This feedback opportunity will gain confidence in the use and success of RealTimeResume.com 200.

RealTimeResume.com 200 also allows individuals 400, employers 300 and consumers 500 to advertise 274 successful matches. RealTimeResume.com 200 also provides prizes and incentives 275 to individuals 400, employers 300 and consumers 500 for using the system as well as templates 276 for users to complete for their personal profile 212 and personalized website 214. Prizes and incentives 275 can include prizes and incentives from advertising sponsors on RealTimeResume.com 200.

RealTimeResume.com 100 will have a positive and profound impact on the way the employment & business industry engages in daily interviews. The ability to engage in a RealTimeResume.com video conference from anywhere in the world, will minimize interview time and eliminate initial interview travel. RealTimeResume.com's ultimate goal: encouraging and promoting economic global conservation while fostering employment and business opportunities to millions of people daily throughout the United States and abroad!

FIG. 1 can also be used to describe the above elements, the RealTimeResume.com system 100, according to four major groupings, RealTimeResume.com 200, the individual 400, the employer 300 and consumers 500.

RealTimeResume.com 200:

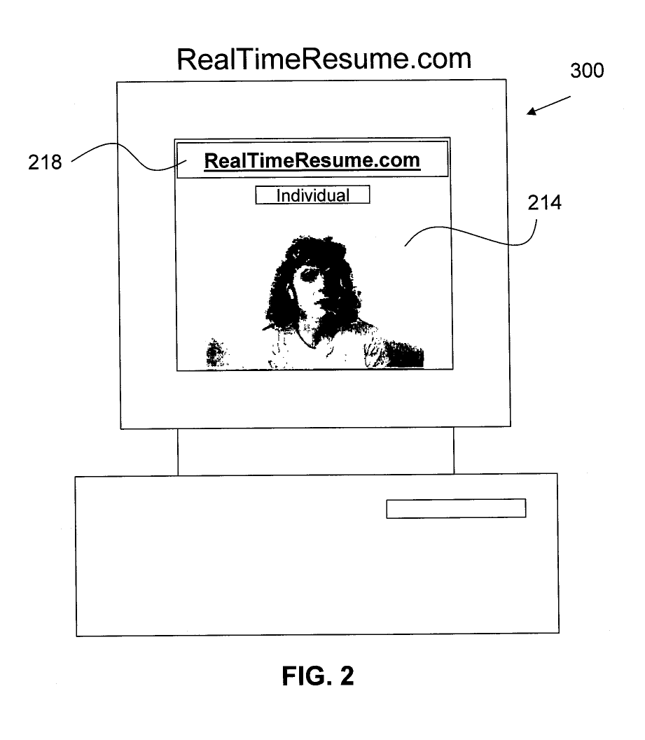

RealTimeResume.com 200 provides a simple and easy to access website 218 that also provides personalized websites 214 for users. FIG. 2 illustrates one embodiment of a personalized website 214 on the RealTimeResume.com website 218 as it would look to an employer 300 or a consumer 500. The website 218 allows the uploading of personal profile information 212 such as achievements, attributes, qualities and strengths. The personalized website 214 can include profile information 212 of the individual 400 such as a personalized resume 412 which can include a video clip 414. The personalized profile 212 can also include business profile information 213.

RealTimeResume.com 200 provides services such as assigning a secured screen name 252, instant messaging 272, categorizing 216 the personal profile 212 and business profile 213 and hit tracking 262 of the personalized website 214.

RealTimeResume.com 200 also allows only the resume owner 400 and RealTimeResume.com 200 to alter the personalized website 214.

RealTimeResume.com 200 also categorizes website 218 content by personal profiles 212 and business profiles 213 with links 266 connecting to field, expertise, company, zip code, salary, benefits etcetera.

RealTimeResume.com 200 also allows employers 300 or other consumers 500 to engage in real time interviews 270 and 272 with the individual 400 at the click of a button 307.

RealTimeResume.com 200 also allows the screen name 252 to flash when the owner 400 is online at the same time their personal profile 212 or business profile 213 is being read.

RealTimeResume.com 200 also allows the person reading the resume 212 to send an instant message 322 and 422 requesting an opportunity to engage in an instant real time resume interview 270 and 272.

RealTimeResume.com 200 also allows employers 300, consumers 500 and individuals 400 to engage in a real time video conference 270.

RealTimeResume.com 200 also allows audible alerts 254 and visual alerts 256 that alert when the individual 400 is online the same time their personal profile 212 or business profile 213 is being read. The alerts can be used to provide instant matching 260 of the employer 300, consumer 500 and an individual 400 to engage in an instant interview 270 and 272.

Once an interview has taken place on RealTimeResume.com 200, RealTimeResume.com 200 also provides the potential employee 400 and the employer 300 to have the ability to provide a feedback response 264.

Through content blocking 268, RealTimeResume.com 200 also does not tolerate pornographic or any inappropriate video of any kind. Any attempt made to do so will result in immediate legal intervention and prosecution to the fullest extent of the law.

RealTimeResume.com 200 also allows individuals 400, employers 300 and consumers 500 to advertise 274 successful matches. RealTimeResume.com 200 also provides prizes and incentives 275 to individuals 400, employers 300 and consumers 500 as well as templates 276 for users to complete for their personal profile 212 and personal website 214. Prizes and incentives 275 can include prizes and incentives from advertising sponsors on RealTimeResume.com 200.

Individual 400:

The RealTimeResume.com system 100 gives an individual 400 simple and easy access to a website 218 and a personalized website 214 through a website access 405. The individual 400 is assigned a secured screen name 252. The individual 400 can upload a personalized resume 412 which can include a video clip 414 that articulates the owner's profile 212 to include achievements, attributes, qualities and strengths. The individual 400 can be promoting their own skills with their personal profile 212, which can include a business profile 213 for promoting their own business. The RealTimeResume.com system 100 allows the individual 400 to send an instant message 422, search 258 and engage in live video 424 interviews 270 at the click of a button 407 from anywhere in the world. The RealTimeResume.com system 100 also allows the individual 400 to see the number of hits 262 made on their personalized website 214.

The RealTimeResume.com system 100 gives the individual 400 the ability to alter their personalized website 214.

The RealTimeResume.com system 100 also allows the individual 400 to view website 218 content by personal profiles 212 and business profiles 213 with links 266 connecting to field, expertise, company, zip code, salary, benefits etcetera.

The RealTimeResume.com system 100 also allows individuals 400 to engage in real time interviews 270 and 272 with employers 300 or other consumers 500 at the click of a button 407.

The RealTimeResume.com system 100 also allows the individual's screen name 252 to flash when the individual 400 is online at the same time their personal profile 212 or business profile 213 is being read.

The RealTimeResume.com system 100 also allows the person reading the resume 212 to send an instant message 322 requesting an opportunity to engage in an instant real time resume interview 270 and 272.

The RealTimeResume.com system 100 also allows the individual 400 to utilize live video 424 to engage in a real time video conference 270 with employers 300 or consumers 500.

The RealTimeResume.com system 100 also allows the individual 400 to receive audible alerts 254 and visual alerts 256 when they are online the same time their profile 212 is being read. The alerts can be used to provide instant matching 260 of the individual 400 and the employer 300 to engage in an instant interview 270 and 272.

Once an interview has taken place on RealTimeResume.com 200, the RealTimeResume.com system 100 also provides the potential employee 400 with the ability to provide a feedback response 264.

Employer 300 and Consumer 500:

To simplify this description, and the elements of FIG. 1, the functional elements for the employer 300 and consumer 500 are identical. The employer 300 elements will be used to describe the invention with the understanding that similar elements and functionality are provided with the consumer 500.

The RealTimeResume.com system 100 gives an employer 300 simple and easy access to a RealTimeResume.com website 218 with personalized websites 214. The employer 300 or consumers 500 are assigned a secured screen name 252. The RealTimeResume.com system 100 allows the employer 300 or consumers 500 to access the personal profile 212 or business profile 213 and read 312, search 258, watch 314, send an instant message 322 and utilize real time video 324 to engage in real time video 324 interviews 270 with the individual 400 at the click of a button 307.

The RealTimeResume.com system 100 also allows the employer 300 or consumer 500 to view 324 RealTimeResume.com website 218 content by personal profiles 212 and business profiles 213 with links 266 connecting to field, expertise, company, zip code, salary, benefits etcetera.

The RealTimeResume.com system 100 also allows the employer 300 or consumer 500 to receive audible alerts 254 and visual alerts 256 when the individual 400 is online when their personal profile 212 or business profile 213 is being read. The alerts can be used to provide instant matching 260 of the employer 300 and the individual 400 to engage in an instant interview 270 and 272.

Once an interview has taken place on RealTimeResume.com 200, the RealTimeResume.com system 100 also provides the employer 300 or consumer 500 with the ability to provide a feedback response 264.

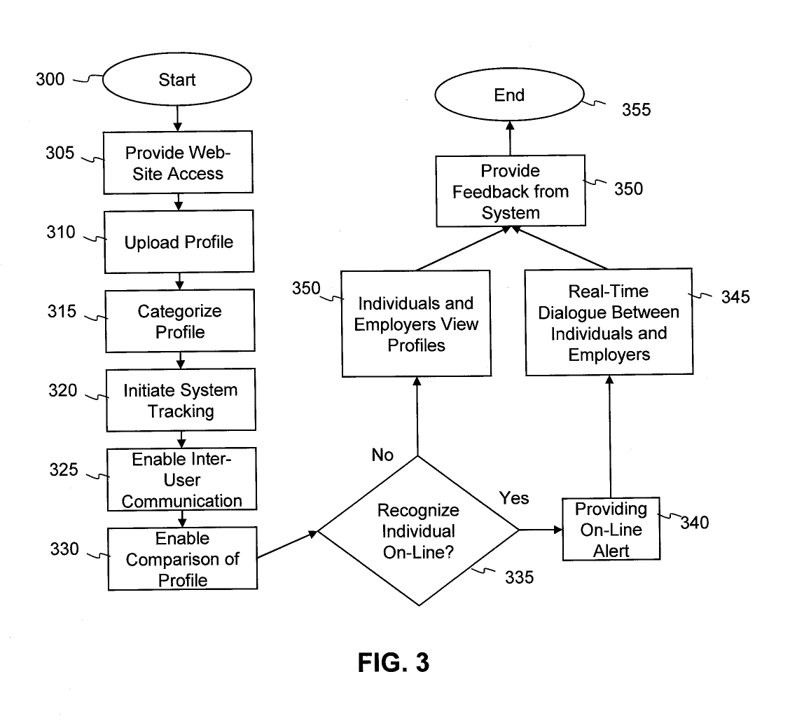

The methods to utilize the elements described above are illustrated in a process flow diagram in FIG. 3. The following description includes references to the RealTimeResume.com system 100 elements included in the description above and shown in FIG. 1 and FIG. 2.

Referring to FIG. 3, after starting at step 300, step 305 is the providing of a simple and easy website 218 access to individuals 400, employers 300 or consumers 500. Access is provided by assigning a secured screen name 252 to the individual 400, employer 300 or consumer 500.

In step 310, the individual 400 uploads a personalized resume 412 to their own personalized website 214 which can include a video clip 414 that articulates the owner's profile 212 or business profile 213 to include achievements, attributes, qualities and strengths.

Next, in step 315, RealTimeResume.com 200 categorizes personal profiles 212 and business profiles 213 by field, expertise, company, zip code, salary, benefits etcetera.

Next, in step 320, RealTimeResume.com 200 initiates processes to support the provision of audible alerts 254, flash alerts 256, content blocking 268, hit tracking 262, feedback 264, links 266, prizes/incentives 275, advertising 274 and templates 276.

Steps 325 and 330 are listed in sequence; however, they may be performed in parallel and in any order.

In step 325, RealTimeResume.com 200 enables individuals 400, employers 300 or consumers 500 to send instant messages 272 and request and engage in real time video interviews 270.

In step 330, RealTimeResume.com 200 enables individuals 400, employers 300 or consumers 500 to search 258 and match 260 personal profiles 212 and business profiles 213.

In step 335, RealTimeResume.com 200 enables recognition of when an individual 400 is on-line.

Steps 340 and 345 are started depending on whether the individual 400 is on-line or not. Therefore, either step 340 or 345 occur after step 335.

In step 340, RealTimeResume.com 200 provides a visual alert 256 or audible alert 254 when an individual 400 is on-line when their profile 212 is being read or searched 258.

In step 345, RealTimeResume.com 200 enables a real time interview 270 or 272 between the individual 400, employer 300 or consumer 500.

In step 350, RealTimeResume.com 200 continues to operate and track even if the individual 400 is not on-line. Individuals 400, employers 300 or consumers 500 are able to view personal profiles 212, business profiles 213 and other information.

In step 355, RealTimeResume.com 200 allows users of the system to provide feedback response 264 after using the system such as with a real time interview 324.

The process is complete with step 355.

1. The claim of RealTimeResume.com is to have a positive and profound impact on the way the employment & business industry engage in daily interview. The ability to engage in a RealTimeResume.com instant message, video conference from anywhere in the world, will minimize interview time and eliminate initial interview travel. RealTimeResume.com's ultimate goal: encouraging and promoting economic global conservation while fostering employment and business opportunities to millions of people daily throughout the United States and abroad!

2. A web-based communication system comprising:
a realtimeresume.com system having a website which is network accessible by one or more individuals, employers or consumers;
an access means allowing said realtimeresume.com system to provide access to said website to said individuals, said employers or said consumers;
said individuals, employers and consumers having profile information reflecting attributes of said individuals, employers and consumers respectively;
an upload means allowing said individuals, said employers and said consumers to upload said profile information on said realtimeresume.com system and see or search the said profile information of each other;
a search means allowing said individuals, employers and consumers to search profile information of each other; and
a communication means allowing said individuals, employers and consumers to engage in real-time communication.

3. The web-based communication system of claim 2 wherein:
Said website further comprises a personalized website containing said profile information of said individuals, said employers and said consumers.

4. The web-based communication system of claim 3 further comprising:
a recognizing means to recognize when said individual, employer or consumer are network accessible and said profile is being seen or searched on said website by one or more of said individuals, employers or said consumers.

5. The web-based interview system of claim 4 further comprising:
an alert means to visually notify said individual, employer or consumer is network accessible when their profile is being seen or searched by one or more of said individuals, employers or said consumers.

6. The web-based interview system of claim 5 further comprising:
an alert means to audibly notify said individual, employer or consumer is network accessible when their profile is being seen or searched by one or more of said individuals, employers or said consumers.

7. The web-based interview system of claim 6 further comprising:
a feedback means allowing said individuals, employers and consumers to share information after they have real-time communication.
an advertising means allowing said individuals, employers and consumer to advertise on said website;
a content blocking means allowing said realtimeresume.com system to prevent inappropriate content from being viewed on said website;
a template providing means allowing said realtimeresume.com system to provide one or more templates for said individuals, employers and consumers to easily upload said profile information;
a categorization means allowing said realtimeresume.com system to categorize said profile information and said personalized websites; and
a linking means allowing said profile information on said website to link to profile information on said personalized website.

8. A web-based communication system comprising:
a realtimeresume.com system having a website which is network accessible by one or more individuals, employers or consumers;
an access means allowing said realtimeresume.com system to provide access to said website to said individuals, said employers or said consumers;
said individuals, employers and consumers having profile information reflecting attributes of said individuals, employers and consumers respectively;
an upload means allowing said individuals to upload said profile information on said realtimeresume.com system and allow said individuals, employers and consumers to see or search the said profile information;
a search means allowing said individuals, employers and consumers to search said profile information; and
a communication means allowing said individuals, employers and consumers to engage in real-time communication.

9. The web-based communication system of claim 8 wherein:
said website further comprises a personalized website containing said profile information of said individuals.

10. The web-based communication system of claim 9 further comprising:
a recognition means to recognize when said individual, employer or consumer are network accessible and said profile is being seen or searched on said website by one or more of said individuals, employers or said consumers.

11. The web-based interview system of claim 10 further comprising:
an alert means to visual notify said individual when said profile is being seen or searched by one or more of said individuals, employers or said consumers.

12. The web-based interview system of claim 11 further comprising:
an alert means to visual notify said individual when said profile is being seen or searched by one or more of said individuals, employers or said consumers.

13. The web-based interview system of claim 12 further comprising:
a feedback means allowing said individuals, employers and consumers to share information after they have real-time communication;
an advertising means allowing said individuals, employers and consumer to advertise on said website;
a content blocking means allowing said realtimeresume.com system to prevent inappropriate content from being viewed on said website;
a template providing means allowing said realtimeresume.com system to provide one or more templates for said individuals, employers and consumers to easily upload said profile information;
categorization means allowing said realtimeresume.com system to categorize said profile information and said personalized websites; and
linking means allowing said profile information on said website to link to profile information on said personalized website.

14. A method of enhancing communication between a plurality of parties, said methods comprising:
providing access to one or more individuals, employers or consumers to a realtimeresume.com website;
uploading a personalized profile of said individual, said employer or said consumer to said website;
categorizing said personalized profiles;
initiating processes to support provisioning of a plurality of realtimeresume.com services;
performing one or both of the following steps in any order:
(i) enabling said individuals, employers or consumers to send instant messages and request and engage in real-time communication;
(ii) enabling said individuals, employers or consumers to search and match said personalized profiles;
recognizing when said individual, employer or consumer is network accessible at the same time another of said individuals, employers or consumers are network accessible;
performing one or more of the following steps in any order:
(i) providing an alert when said individual, employer or consumer is network accessible when their said personalized profile is being seen or searched;
(ii) enabling real-time communication between said individual, said employer or said consumer;
(iii) enabling said individuals, said employers and said consumers to see or search said personalized profiles; and
allowing said individuals, said employers and said consumers to provide feedback to said realtimeresume.com website.

15. The method of enhancing communication between a plurality of parties of claim 14 wherein:
said alert comprises a visual alert means to visual notify said individual, employer or consumer is network accessible when said personalized profile is being seen or searched by one or more of said employers or said consumers.

16. The method of enhancing communication between a plurality of parties of claim 15 wherein:
said alert comprises a audible alert means to audibly notify said individual, employer or consumer is network accessible when said personalized profile is being seen or searched by one or more of said employers or said consumers; and
said plurality of realtimeresume.com services further comprise:
(i) an advertising means allowing said individuals, employers and consumer to advertise on said website;
(ii) a content blocking means allowing said realtimeresume.com system to prevent inappropriate content from being viewed on said website;
(iii) a template providing means allowing said realtimeresume.com system to provide one or more templates for said individuals, employers and consumers to easily upload said personalized profile information;
(iv) a categorization means allowing said realtimeresume.com system to categorize said personalized profile information and said personalized websites; and
(v) a linking means allowing said personalized profile information on said website to link to said personalized profile information on said personalized website.

17. A method of enhancing communication between a plurality of parties, said methods comprising:
providing access to one or more individuals, employers or consumers to a realtimeresume.com website;
uploading a personalized profile of said individual to said website;
categorizing said personalized profiles;
initiating processes to support provisioning of a plurality of realtimeresume.com services;
performing one or both of the following steps in any order:
(i) enabling said individuals, employers or consumers to send instant messages and request and engage in real-time communication;
(ii) enabling said individuals, employers or consumers to search and match said personalized profiles;
recognizing when said individual, employer or consumer is network accessible at the same time another of said individuals, employers or consumers are network accessible;
performing one or more of the following steps in any order:
(i) providing an alert when said individual is network accessible when their said personalized profile is being seen or searched;
(ii) enabling real-time communication between said individual, said employer and said consumer;
(iii) enabling said individuals, said employers and said consumers to see or search said personalized profiles; and
allowing said individuals, said employers and said consumers to provide feedback to said realtimeresume.com website.

18. The method of enhancing communication between a plurality of parties of claim 17 wherein:
said alert comprises a visual alert means to visual notify said individual, employer or consumer is network accessible when said personalized profile is being seen or searched by one or more of said employers or said consumers.

19. The method of enhancing communication between a plurality of parties of claim 18 wherein:
said alert comprises an audible alert means to audibly notify said individual, employer or consumer is network accessible when said personalized profile is being seen or searched by one or more of said employers or said consumers; and
said plurality of realtimeresume.com services further comprise:
(i) an advertising means allowing said individuals, employers and consumer to advertise on said website;
(ii) a content blocking means allowing said realtimeresume.com system to prevent inappropriate content from being viewed on said website;
(iii) a template providing means allowing said realtimeresume.com system to provide one or more templates for said individuals, employers and consumers to easily upload said personalized profile information;
(iv) a categorization means allowing said realtimeresume.com system to categorize said personalized profile information and said personalized websites; and
(v) a linking means allowing said personalized profile information on said website to link to said personalized profile information on said personalized website.
